(19) United States
(12) Patent Application Publication
(10) Pub. No.: US 2020/0150997 A1
(43) Pub. Date: May 14, 2020

(54) WINDOWS LIVE MIGRATION WITH TRANSPARENT FAIL OVER LINUX KVM

(71) Applicants: Yu Bruce Chang, Portland, OR (US); Mitu Aggarwal, Portland, OR (US); Jani Nrupal, Hillsboro, OR (US); Ramanathan Ramanathan, Hillsboro, OR (US)

(72) Inventors: Yu Bruce Chang, Portland, OR (US); Mitu Aggarwal, Portland, OR (US); Jani Nrupal, Hillsboro, OR (US); Ramanathan Ramanathan, Hillsboro, OR (US)

(21) Appl. No.: 16/745,825

(22) Filed: Jan. 17, 2020

(51) Int. Cl. G06F 9/455; G06F 13/20; G06F 13/42

(52) U.S. Cl. CPC G06F 9/45558; G06F 13/20; G06F 2009/45579; G06F 2213/0026; G06F 2009/4557; G06F 13/4282

(57) ABSTRACT

Methods, software, and apparatus for implementing live migration of virtual machines hosted by a Linux operating system (OS) and running a Microsoft Windows OS. Communication between the VM and a network device is implementing using a virtual function (VF) datapath coupled to a Single-root input/output virtualization (SR-IOV) VF on the network device and an emulated interface coupled to a physical function on the network device, wherein the emulated interface employs software components in a Hypervisor, and the VF datapath bypasses the Hypervisor. In one aspect, the VF datapath is active when the SR-IOV VF is available, and the datapath fails over to the emulated data path when the SR-IOV VF is not available. Disclosed live migration solutions employ Windows NDIS (Network Driver Interface Specification) components including NDIS Miniport interfaces and MUX IM drivers, enabling live migration to be transparent to the Windows OS. NetKVM drivers are also used for Linux Hypervisors including KVM.

### BACKGROUND INFORMATION

During the past decade, there has been tremendous growth in the usage of so-called “cloud-hosted” services. Examples of such services include e-mail services provided by Microsoft® (Hotmail/Outlook online), Google® (Gmail) and Yahoo® (Yahoo mail), productivity applications such as Microsoft® Office 365 and Google Docs, and Web service platforms such as Amazon® Web Services (AWS) and Elastic Compute Cloud (EC2) and Microsoft® Azure. Cloud-hosted services are typically implemented using data centers that have a very large number of compute resources, implemented in racks of various types of servers, such as blade servers filled with server blades and/or modules and other types of server configurations (e.g., 1U, 2U, and 4U servers).

In recent years, virtualization of computer systems has also seen rapid growth, particularly in server deployments and data centers. Under a conventional approach, a server runs a single instance of an operating system directly on physical hardware resources, such as the CPU, RAM, storage devices (e.g., hard disk), network controllers, input-output (IO) ports, etc. Under one virtualized approach using Virtual Machines (VMs), the physical hardware resources are employed to support corresponding instances of virtual resources, such that multiple VMs may run on the server's physical hardware resources, wherein each virtual machine includes its own CPU allocation, memory allocation, storage devices, network controllers, IO ports etc. Multiple instances of the same or different operating systems then run on the multiple VMs. Moreover, through use of a virtual machine manager (WM) or “hypervisor” or “orchestrator,” the virtual resources can be dynamically allocated while the server is running, enabling VM instances to be added, shut down, or repurposed without requiring the server to be shut down. This provides greater flexibility for server utilization, and better use of server processing resources, especially for multi-core processors and/or multi-processor servers.

Under another virtualization approach, container-based OS virtualization is used that employs virtualized “containers” without use of a VMM or hypervisor. Instead of hosting separate instances of operating systems on respective VMs, container-based OS virtualization shares a single OS kernel across multiple containers, with separate instances of system and software libraries for each container. As with VMs, there are also virtual resources allocated to each container.

Para-virtualization (PV) is a virtualization technique introduced by the Xen Project team and later adopted by other virtualization solutions. PV works differently than full virtualization—rather than emulate the platform hardware in a manner that requires no changes to the guest operating system (OS), PV requires modification of the guest OS to enable direct communication with the hypervisor or VMM. PV also does not require virtualization extensions from the host CPU and thus enables virtualization on hardware architectures that do not support hardware-assisted virtualization. PV IO devices (such as virtio, vmxnet3, netvsc) have become the de facto standard of virtual devices for VMs. Since PV IO devices are software-oriented devices, they are friendly to cloud criteria like live migration.

While PV IO devices are cloud-ready, their IO performance is poor relative to solutions supporting IO hardware pass-through VFs (virtual functions), such as single-root input/output virtualization (SR-IOV). However, pass-through methods such as SR-IOV (Single-root Input/Output Virtualization) have a few drawbacks. For example, when performing live migration, the hypervisor/VMM is not aware of device stats that are passed through to the VM and transparent to the hypervisor/VMM.

In some virtualized environments, a mix of different operating system types from different vendors are implemented. For example, Linux-based hypervisors and VMs (such as Kernel-based Virtual Machines (KVMs) and Xen hypervisors) dominate cloud-based services provided by AWS and Google®, and have been recently added to Microsoft® Azure. At the same time, Microsoft® Windows operating systems dominates the desktop application market. With the ever-increasing use of cloud-hosted Windows applications, the use of Microsoft® Windows guest operating systems hosted on Linux-based VMs and hypervisors has become more common. However, on KVM and Xen hypervisors, the ability to live migrate a virtual machine hosting a Windows guest OS that has an SR-IOV VF attached to it has yet to be supported.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating selective software and hardware components of a host platform architecture implementing a first embodiment of a live migration solution employing a Windows NDIS (Network Driver Interface Specification) MUX IM (intermediate) driver;

FIG. 2 is a block diagram of a Linux KVM (Kernel-based Virtual Machine) architecture used to host multiple virtual machines;

FIG. 3 is a schematic diagram illustrating selective software and hardware components of a host platform architecture implementing a second embodiment of a live migration solution employing a NetKVM driver with an integrated Windows NDIS MUX IM driver

FIG. 4a is a schematic diagram illustrating a first state corresponding to ongoing operations under which a source VM employing the host platform architecture of FIG. 3 is using a VF datapath as the active datapath;

FIG. 4b is a schematic diagram illustrating a pre-migration state under which the datapath has been switched from the VF datapath to the emulated datapath in preparation for live migration of the VM;

FIG. 4c is a schematic diagram illustrating instantiation of a destination VM and Windows OS on a destination host to which the source VM is to be migrated;

FIG. 4d is a schematic diagram illustrated an initial post migration state under which the emulated datapath is active on the destination VM;

FIG. 4e is a schematic diagram illustrating ongoing operations on the destination VM following the initial post migration state under which the datapath has been switched from the emulated datapath to the VF datapath;

FIG. 5 is a flowchart illustrating operations performed on a source host and destination host in connection with migrating a source VM to the destination host; according to one embodiment;

FIG. 6a is a is a schematic diagram of a platform architecture configured to implement the software architecture shown in FIGS. 3 and 4a-4e using a System on a Chip (SoC) connected to a network device comprising a NIC, according to one embodiment; and

FIG. 6b is a is a schematic diagram of a platform architecture configured to implement the software architecture of FIG. 1 using an SoC connected to a network device comprising a NIC, according to one embodiment.

### DETAILED DESCRIPTION

Embodiments of methods, software, and apparatus for implementing live migration of virtual machines hosted by a Linux OS and running a Windows OS are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments disclosed herein, solutions are provided that support live migration of virtual machines hosted by a Linux OS and running instances of Windows OS that have an SR-IOV VF attached to them. The solutions are implemented, in part, with software components implementing standard Windows interfaces and drivers to support compatibility with existing and future versions of Windows operating systems. Communication between the VM and a network device is implementing using a virtual function (VF) datapath coupled to an SR-IOV VF on the network device and an emulated interface coupled to a physical function on the network device, wherein the emulated interface employs software components in a Linux Hypervisor, and the VF datapath is a pass-through VF that bypasses the Hypervisor. In preparation for live migration, the active datapath used by the source VM on the source host is switched from the VF datapath to the emulated datapath, enabling the Hypervisor on the source host to track dirtied memory pages during the live migration. After an initial post migration state following the live migration during which the emulated datapath is used by the destination VM on the destination host, the active datapath for the destination VM is returned to the VF datapath.

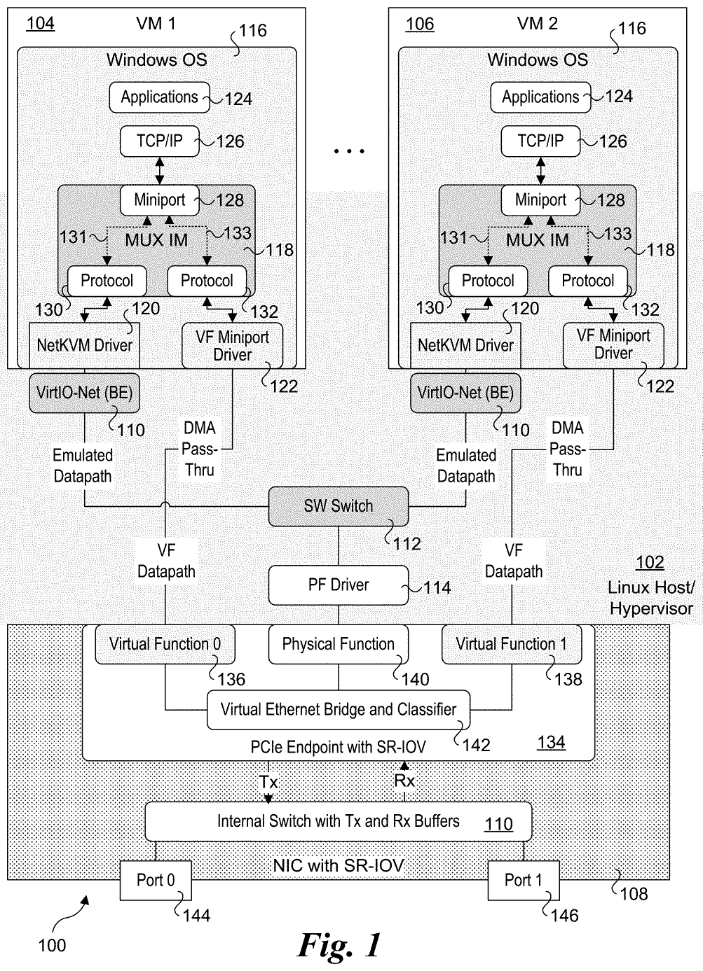

FIG. 1 shows selective software and hardware components of a host platform architecture 100 implementing a first embodiment of the solution employing a Windows NDIS (Network Driver Interface Specification) MUX IM (intermediate) driver. Architecture 100 includes a Linux host OS and Hypervisor 102 hosting a plurality of VMs, including a VM 102 and a VM 104 (also labeled and referred to as VM 1 and VM 2). Generally, a Linux host platform may host one or more VMs. The hardware component illustrated in FIG. 1 is a network device comprising a network interface controller (NIC) 108 with support for SR-IOV virtual functions.

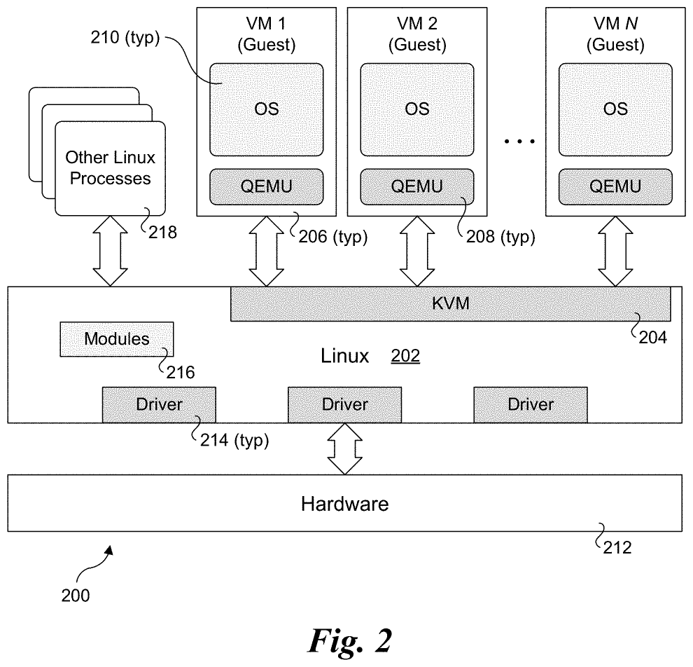

In one embodiment, architecture 100 is implemented using a Linux KVM (Kernel-based Virtual Machine) architecture, such as illustrated in Linux KVM architecture 200 of FIG. 2. Under modern versions of Linux, Hypervisor functionality is tightly integrated into the Linux code base and provide enhanced performance when compared with VMM and Type-2 Hypervisors that are run as application in the host's user space. As a result, Linux KVM architectures are widely deployed in datacenters and/or to support cloud-based services.

As illustrated in FIG. 2, Linux KVM architecture 200 employs a Linux operating system 202 including KVM 204 that is used to host N virtual machines 206, which the VMs are also referred to as guests. Each VM 206 includes QEMU 208. QEMU (short for Quick EMUlator) is an open-source emulator that performs platform hardware virtualization and is a hosted virtual machine monitor (VMM). An instance of an OS 210 is run in each VM 206. Under Linux KVM architecture 200, the OS is implemented as a user space process using QEMU for x86 emulation. Other components illustrated in Linux KVM architecture 200 include a hardware layer 212, Linux drivers 214, Linux modules 216 and other Linux processes 218. As will be recognized by those skilled in the virtualization art, the Linux KVM architecture also includes additional components that are implemented in VMs 206 that are not shown for simplicity. This KVM implementation is referred to as a Hypervisor, observing that unlike some Hypervisor architectures, under the Linux KVM architecture the Hypervisor components are not implemented in a single separate layer (e.g., such as a Type-2 Hypervisor), but rather include software components in the Linux kernel as well as software components in the VMs (implemented in the host's user space).

Returning to FIG. 1, in addition to KVM 204 (which is not shown for simplicity and lack of space), Linux host/Hypervisor 102 includes a VirtIO-Net Backend (BE) 110, a software switch 112 (also referred to as a virtual switch or vSwitch), and a Physical Function (PF) driver 114). VirtIO-NET is an emulated interface present in Linux. Each of VM 104 and 106 has an identical configuration comprising a Windows OS 116 including an NDIS MUX IM driver 118, a NetKVM driver 120, and a Virtual Function (VF) Miniport driver 122. As further depicted, Windows OS 116 includes applications 124 and a TCP/IP (Transmission Control Protocol/Internet Protocol) driver 126 that is part of the Windows network stack and is coupled to an NDIS Miniport interface 128 on MUX IM driver 118. Miniport interface 128 is internally connected (in MUX IM driver 118) to protocol drivers 130 and 132 via respective communication paths 131 and 133 that can be selectively activated in a manner similar to a multiplexor (MUX) in electric circuitry (hence the name). Protocol driver 130 is coupled to NetKVM driver 120, while protocol driver 132 is coupled to VF Miniport driver 122.

NIC 108 depicts components and interfaces that are representative of a NIC or similar network device, network adaptor, network interface, etc., that provides SR-IOV functionality, as is abstractly depicted by a PCIe (Peripheral Component Interconnect Express) endpoint with SR-IOV block 134. SR-IOV block 134 includes virtual functions 136 and 138, a physical function 140, and a virtual Ethernet bridge and classifier 142. NIC 108 further includes a pair of ports 144 and 146 (also referred to as Port 0 and Port 1) coupled to an internal switch with Tx (transmit) and Rx (receive) buffers 148 that is also coupled to PCIe endpoint with SR-IOV block 134. In the illustrated embodiment, NIC 108 is implemented as a PCIe expansion card installed in an PCIe expansion slot installed in the host platform or a PCIe component or daughterboard coupled to the main board of the host platform.

Network communication between VMs 104 and 106 and NIC 108 may be implemented using two datapaths, one of which is active at a time. Under a first datapath referred to as the “emulated” datapath, the datapath is from Miniport interface 128 to protocol driver 130, NetKVM driver 120, VirtIO-Net 110, SW switch 112, and PF driver 114 to physical function 140. This emulated datapath is a virtualized software-based datapath that is implemented via the aforementioned software components in the Hypervisor and VMs. When the emulated datapath is used, NIC 108 is referred to as the NetKVM device.

Under a second datapath referred to as the VF datapath, communication between a VM 104 or 106 and NIC 108 employs direct memory access (DMA) data transfers over PCIe in a manner that bypasses the Hypervisor (or otherwise is referred to as passing through the Hypervisor or a pass-through datapath). This VF datapath includes the datapath from Miniport interface 128 to protocol driver 132 to VF Miniport driver 122, and from VF Miniport driver 122 to virtual function 136 or 138 (depending on which VM 104 or 106 the communication originates from). When the VF datapath is used, NIC 108 is referred to as the VF device.

It is further noted that each of the emulated datapaths and VF datapaths illustrated herein are bi-directional, and that the complete datapaths between the VMs and a network (not shown) to which NIC 108 is connected includes datapaths internal to NIC 108. For example, an inbound packet (e.g., a packet received at port 144 or 146) will be buffered in an Rx buffer and subsequently copied to a queue (not shown) associated with one of virtual functions 136 and 138 or physical function 140, depending on the destination VM for the packet and whether the emulated datapath or VF datapath is currently active. In addition to the components shown, NIC 108 may including embedded logic or the like for implementing various operations such as but not limited to packet and/or flow classification and generated corresponding hardware descriptors. For outbound packets (e.g., packets originating from a VM and addressed to an external host or device accessed via a network), NIC 108 will include appropriate logic for forwarding packets from virtual functions 136 and 138 and physical function 140 to the appropriate outbound port (port 144 or 146). In addition, each of virtual functions 136 and 138 and physical function 140 will include one or more queues for buffering packets received from the VMs (not shown).

During platform run-time operations, it is preferred to employ the VF datapath when possible as this datapath provides substantial performance improvements over the emulated datapath since it involves no or little CPU overhead (in other words may be implemented without consuming valuable CPU cycles employed for executing software on the host). However, the VF datapath cannot be used during live migration since it provides no means to identify which memory pages are dirtied during the live migration, a function that is provided by the Hypervisor (e.g., as part of built-in functionality provided by Linux host/Hypervisor 102). Thus, a mechanism is needed to switch the VF datapath to the emulated datapath during live migration in a manner that is transparent to the Windows OS running on the VMs.

Under the live migration solution in FIG. 1, NDIS MUX IM driver 118 is used to team NetKVM driver 120 and VF Miniport driver 132. The Windows system protocol driver (such as TCP/IP driver 126) is now bound to the MUX IM driver instead of the VF Miniport driver or the NetKVM driver. MUX IM driver 118 can proxy all traffic, and depending on the availability of the VF device (e.g., MC 108 in FIG. 1), the MUX IM driver can automatically switch its internal datapaths 131 and 133 between the NetKVM driver and the VF Miniport driver to switch between using the emulated datapath for the NetKVM device and VF datapath for the VF device.

With this solution, prior to starting the live migration the VF device is hot-unplugged and MUX IM driver 118 will switch the datapath to the NetKVM device to use the NetKVM device during the live migration. Hence the live migration will continue with no impact to traffic that is running in the VM. Once the migration is complete, the VF instance is hot-added into the migrated-to VM and again put into the team with the MUX IM driver and then the traffic is resumed using the VF datapath.

In this solution, there is no need to change the existing Miniport drivers. The only modifications are the new MUX IM driver, and associated installation packages.

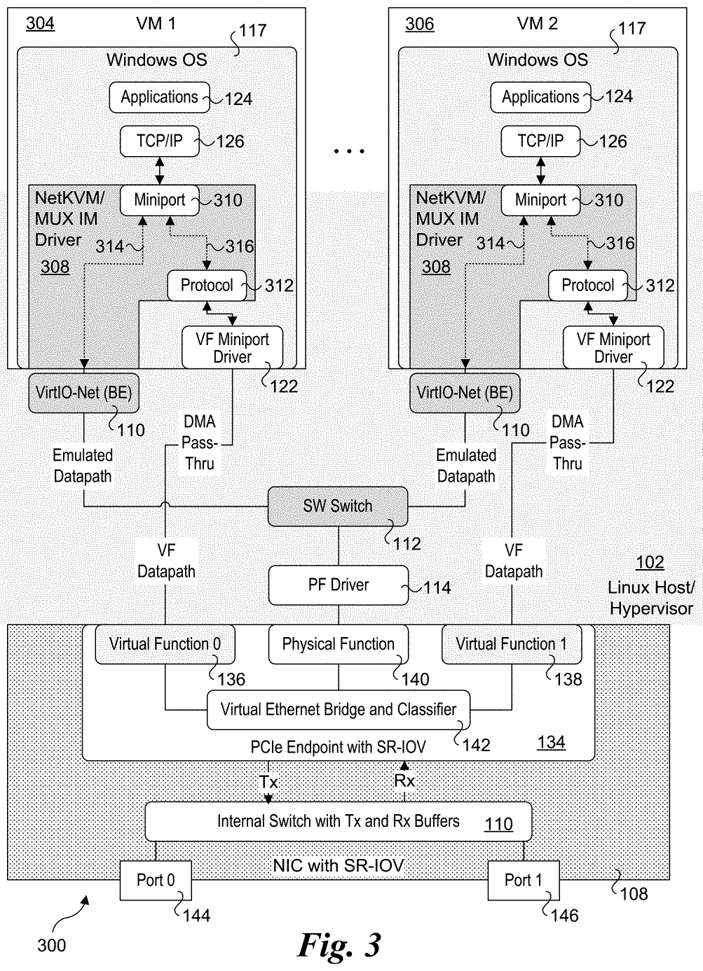

FIG. 3 shows selective software and hardware components of a host platform architecture 300 implementing a second live migration solution referred to as the enslave solution. Under FIGS. 1 and 3, like-numbered components are configured to implement similar functionality, thus the following discussion will focus on the differences between host platform architecture 100 and host platform architecture 300.

In further detail, the differences between platform architectures 100 and 300 are implemented in the instances of Windows OS 116 for architecture 100 and instances of Windows OS 117 in platform architecture 300, which are running on VMs 304 and 306. Each instance of Windows OS 117 employs a NetKVM/MUX IM driver 308 including a Miniport interface 310 and a protocol driver 312. Miniport interface 310 is coupled to protocol driver 312 via an internal communication path 314 and is coupled (via NetKVM/MUX IM driver 308 to VirtIO-Net backend 110 via an internal communication path 316. Protocol driver 312 is connected to VF Miniport driver 122.

Under host platform architecture 300, the emulated datapath is from Miniport interface 310 in NetKVM/MUX IM driver 308 to VirtIO-Net 110, to SW switch 112 to PF driver 114 to physical function 140. The VF datapath is from Miniport interface 310 to protocol driver 312 to VF Miniport driver 122 to virtual function 136 or 138.

A fundamental concept for NetKVM/MUX IM driver 308 in the enslave solution is to extend the NetKVM Miniport driver to include the MUX IM functionality discussed above. This extended NetKVM driver (NetKVM/MUX IM driver 308) has the ability to “enslave” the VF Miniport driver underneath—that is the VF Miniport driver is bound to the NetKVM driver. Like the MUX IM solution in FIG. 1, the NetKVM/MUX IM driver will proxy all networking flows to the VF Miniport if the VF device is available, otherwise it will use the VirtIO-NET directly using the emulated datapath by selectively activating communication paths 314 and 316.

With this solution, the NetKVM/MUX IM driver will use the VF datapath during ongoing runtime operations for the VM. This is done by the protocol edge invoking the system protocol driver directly and bypassing the NetKVM Miniport driver. Then, to set up live migration the VF Miniport driver is ejected and the NetKVM/MUX IM can invoke the emulated VirtIO-Net datapath. This has the advantage of both simplifying the MUX IO driver and speeding up the transfer between the datapaths.

For both solutions, during installation the MUX IM or NetKVM/MUX IM driver will insert itself between the Windows protocol driver and the Miniport drivers. This is accomplished using a utility called notify object that is part of the new driver package.

In the default environment, all traffic will be directed to the VF Miniport driver as it is used by the VF datapath. When live migration starts, the VF device will be unplugged at some point, then the protocol edge of the MUX IM or NetKVM/MUX IM (in the enslave case), will be notified. This will result in switching the traffic to use the emulated VirtIO-Net datapath. At the later stage of the live migration, the SR-IOV VF and VF datapath are enabled again in the destination host, so the protocol driver for the VF Miniport driver will be notified again. The traffic will be resumed to use the VF Miniport driver (and the VF datapath). The switching of the datapath is done internally by the MUX IM driver or NetKVM/MUX IM, which is transparent to the upper layer system protocol driver (and thus also transparent to the operating systems running on the VMs).

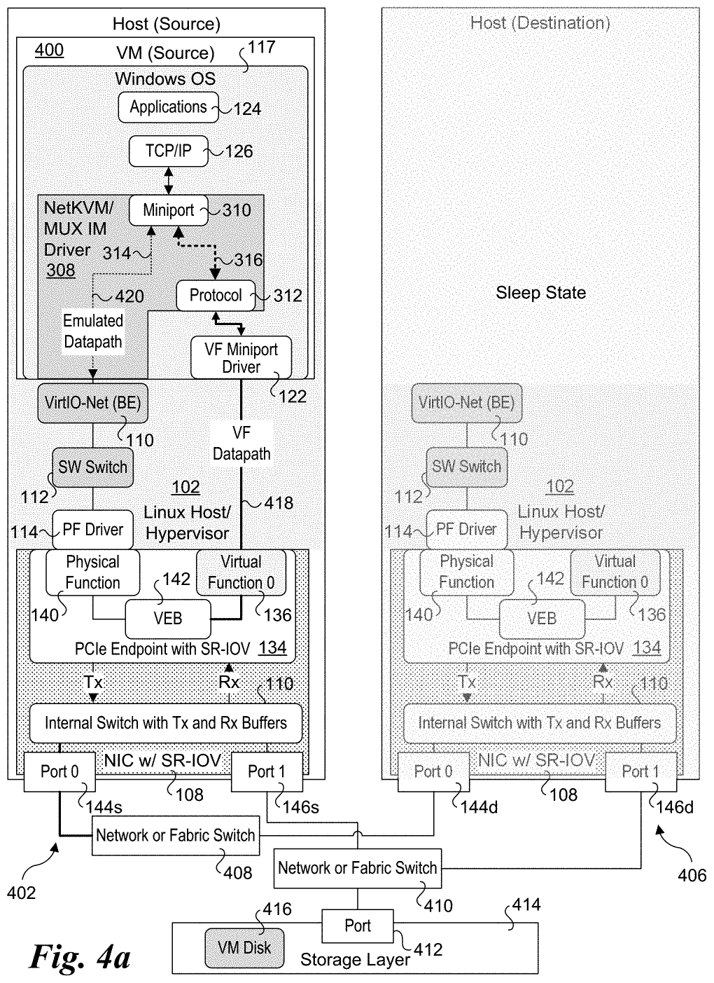

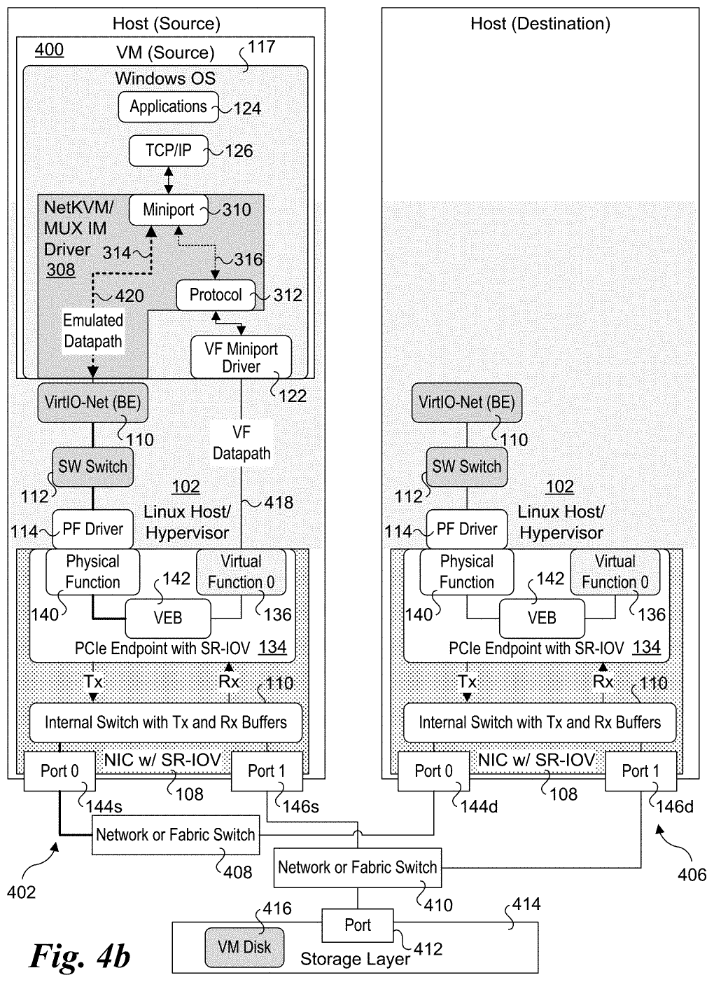

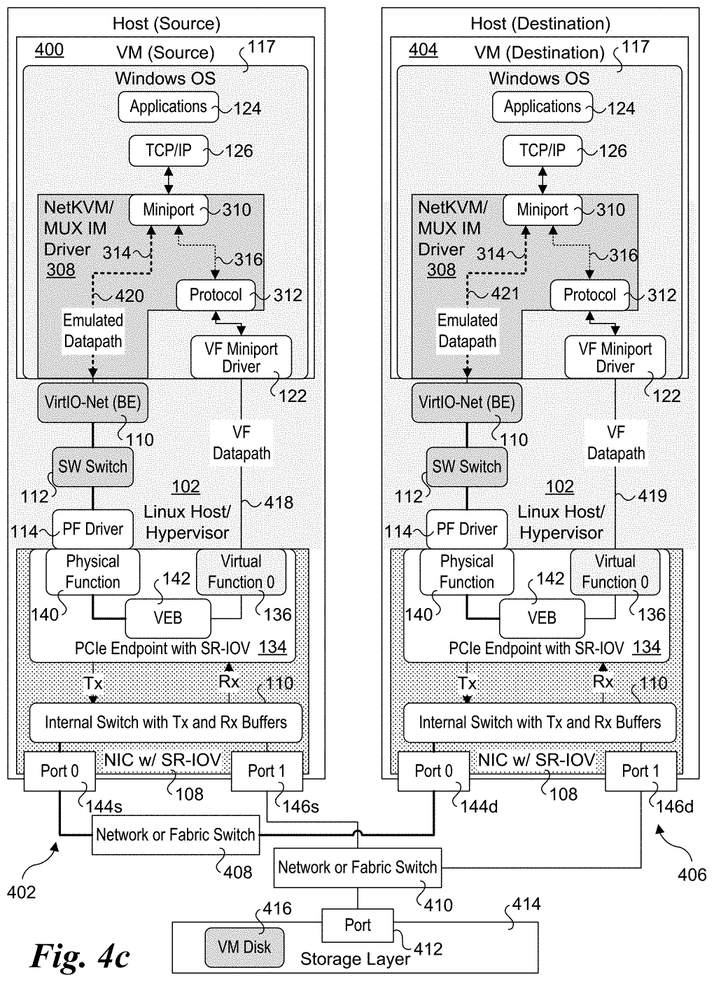

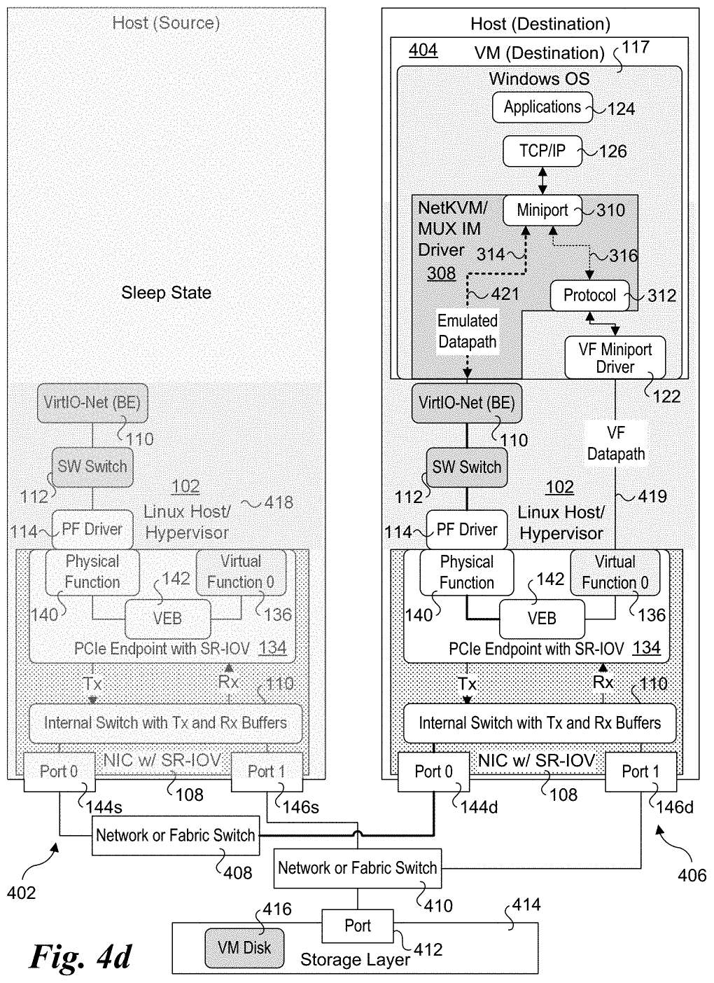

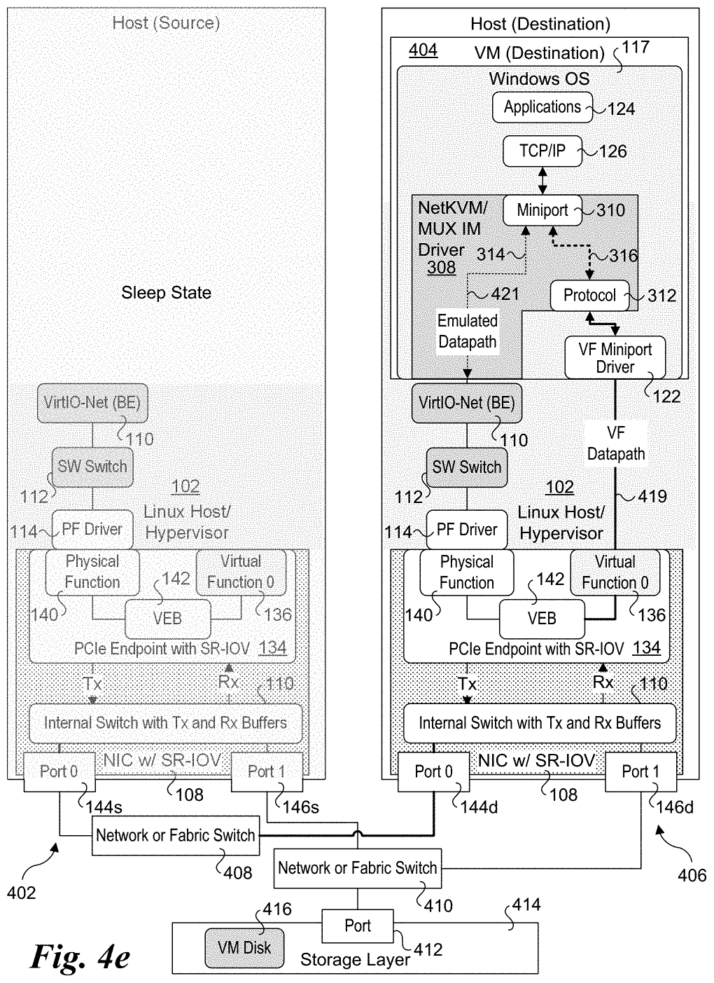

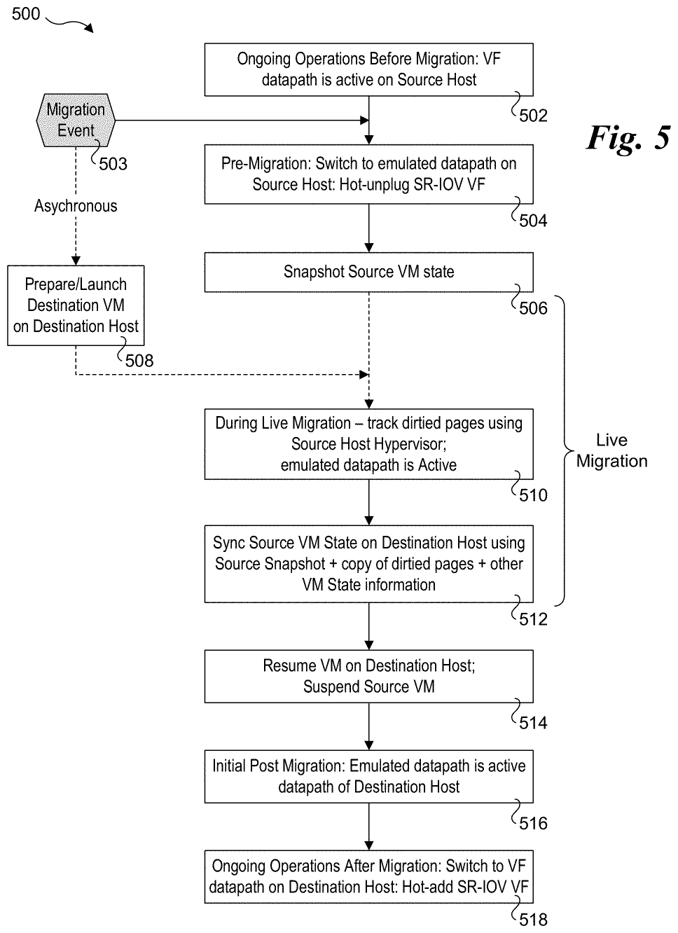

FIGS. 4a-4e and flowchart 500 of FIG. 5 illustrate configuration states and associated operations performed during live migration of a source VM 400 on a source host 402 to a destination VM 404 on a destination host 406 using an embodiment of the enslave solution. As shown in each of FIGS. 4a-4e, source host 402 includes a port 144s connected to a network or fabric switch 408, and a port 146s connected to a network or fabric switch 410. Meanwhile, destination host 406 includes a port 144d connected to network or fabric switch 408, and a port 146d connected to network or fabric switch 410. Network or fabric switch 410 in connected to a port 412 in a network storage layer 414 including a VM disk 416. Generally, network storage layer 414 is representative of a network storage device (or set of storage devices) that are accessed via network or fabric including network or fabric switch 410. In the following example, VM disk 416 may be accessed by source VM 400 during the live migration and may be accessed by destination VM 404 after the migration. Under alternative configurations (not shown) only a single network/fabric switch is used, either with a dual-port NIC or a single-port NIC.

As shown in a block 502 of flowchart 500 and FIG. 4a, during ongoing runtime operations prior to live migration VF datapath 418 is active on source host 402. Also, during this state, destination VM 404 (see FIGS. 4c-4e) has yet to be deployed on destination host 406. For example, it is a common practice to dynamically deploy VMs on different hosts based on changes in demand throughout a workday, wherein VMs are put online and/or taken offline depending on the workload to be supported. It is also common practice to have the Linux software components on the various host platform provisioned in advance, although in some instances Linux components may also be dynamically deployed or taken offline. Under FIG. 4a, the Linux components have been provisioned and destination host 406 is in a sleep state.

As shown in flowchart 500, in response to a migration event 503 the state of source VM 400 is switched to a pre-migration state under which the datapath on source host 402 is switched from VF datapath 418 to emulated datapath 420, as depicted by a block 504 and in FIG. 4b. In one embodiment, the datapath is switched by hot-unplugging VF 136, which is an SR-IOV VF. As another part of the pre-migration state, a snapshot of the state of source VM 404 is taken in a block 506. This generally includes making a copy of the memory pages allocated for the source VM (at least the current used pages), in addition to making a copy of various other VM state information using techniques known in the art. Generally, the snapshot may be stored using volatile or non-volatile storage. In some embodiments the snapshot is written to storage in storage layer 412. In other embodiments, copies of the source VM memory state and other state information are transferred over a network or fabric and written to memory on the destination host without intermediate storage. Under yet another approach (not shown), VM states are periodically checkpointed for each VM on a given host and written to non-volatile storage, and the snapshot represents a “delta” between the current VM state and the last checkpointed state.

After the snapshot is taken, live migration may commence. Asynchronously, or otherwise as a part of the pre-migration operations, preparations are made on the destination host to launch (deploy) the destination VM, as depicted by a block 508. The initial launch state is shown in FIG. 4c. Under this initial launch state, emulated datapath 421 on destination host 406 is the active datapath. Under some embodiments the destination host may not yet be provisioned with the Linux/KVM components (e.g., the host may be shutdown), and thus the Linux/KVM components would need to be provisioned and initialized prior to launching the destination VM.

As shown in a block 510, during the live migration the Hypervisor on the source host tracks dirtied memory pages—that is memory pages allocated to the VM being migrated that are written too during the live migration. Techniques for tracking dirty memory pages using Hypervisors are known in the art and the scheme that may be used is outside the scope of this disclosure. The net result is at the end of the live migration the Hypervisor will have a list of memory pages that have been dirtied during the migration, where the list represents a delta between the memory state of source VM 400 when the snapshot was taken and the memory state at the end of the migration.

At block 512, the state of source VM 400 and destination is restored on destination host 404 such that the states of VM 400 and VM 404 using the snapshot plus a copy of the dirtied memory pages (along with other state information) such that destination VM 404 matches the state of source VM 400 (i.e., the states are synched) Generally, various techniques that are known in the art may be performed for restoring the state of a source VM at the destination VM, with the scheme being outside the scope of this disclosure.

Once the states of the source and destination VMs are synched, the live migration is completed and the logic advances to a block 514 wherein operations (for Windows OS 117 and applications 124) are resume using the destination VM. The source VM is also suspended. This is referred to as the initial post migration state, which is depicted in FIG. 4d. As shown in a block 516, emulated datapath 421 is the active datapath on destination host 406 during this state.

Following the initial post migration state is an ongoing runtime operations state after migration. As depicted in FIG. 4e and a block 518 in flowchart 500, during the ongoing operations after migration state VF datapath 419 is set as the active datapath on destination host 404 (the active datapath is switched from emulated datapath 421 to VF datapath 419). In one embodiment, the active datapath is switched to the VF datapath by hot-adding the SR-IOV VF (VF 136).

A similar sequence to that shown in FIGS. 4a-4e and flowchart 500 of FIG. 5 may be implemented using the Windows NDIS MUX IM driver solution of FIG. 1 to support live migration of a VM running a Windows OS. Under this solution, the datapaths that are active for associated states are shown in TABLE 1:

TABLE 1

| | Source | Destination |
|---|---|---|
| State | Datapath | Datapath |
| Ongoing before | VF Datapath | — |
| Migration | | |
| Pre-migration | Switch to emulated Datapath | — |
| Live-Migration | Emulated Datapath | — |
| Destination VM | Emulated Datapath | Emulated Datapath |
| Launch | | |
| Initial Post | — | Emulated Datapath |
| Migration | | |
| Ongoing following | — | VF Datapath |
| Migration | | |

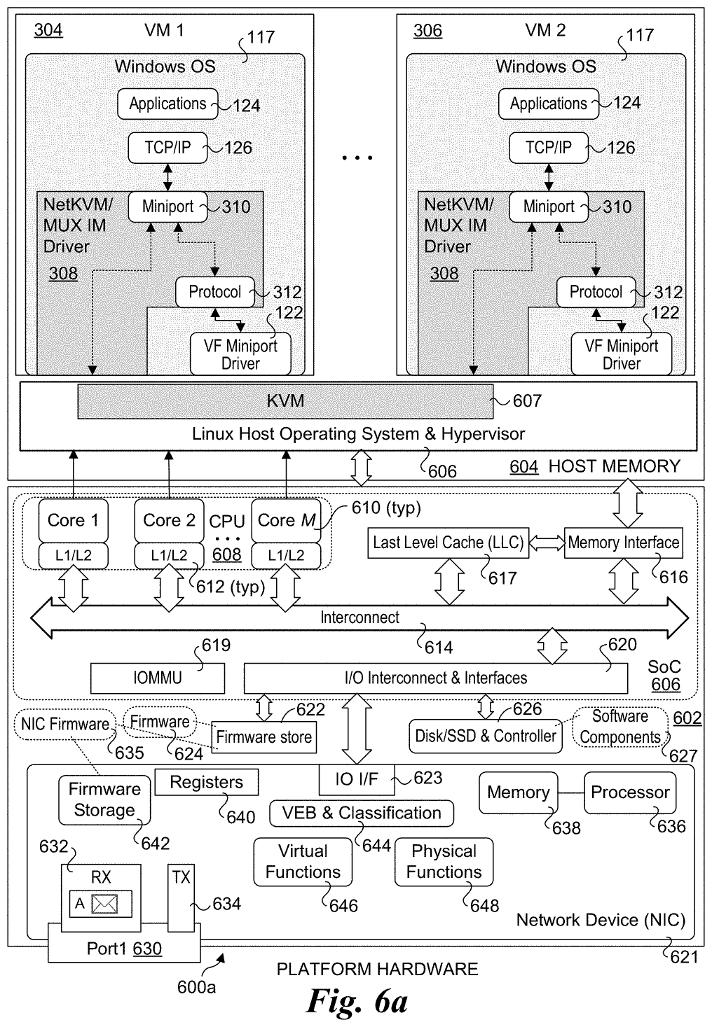

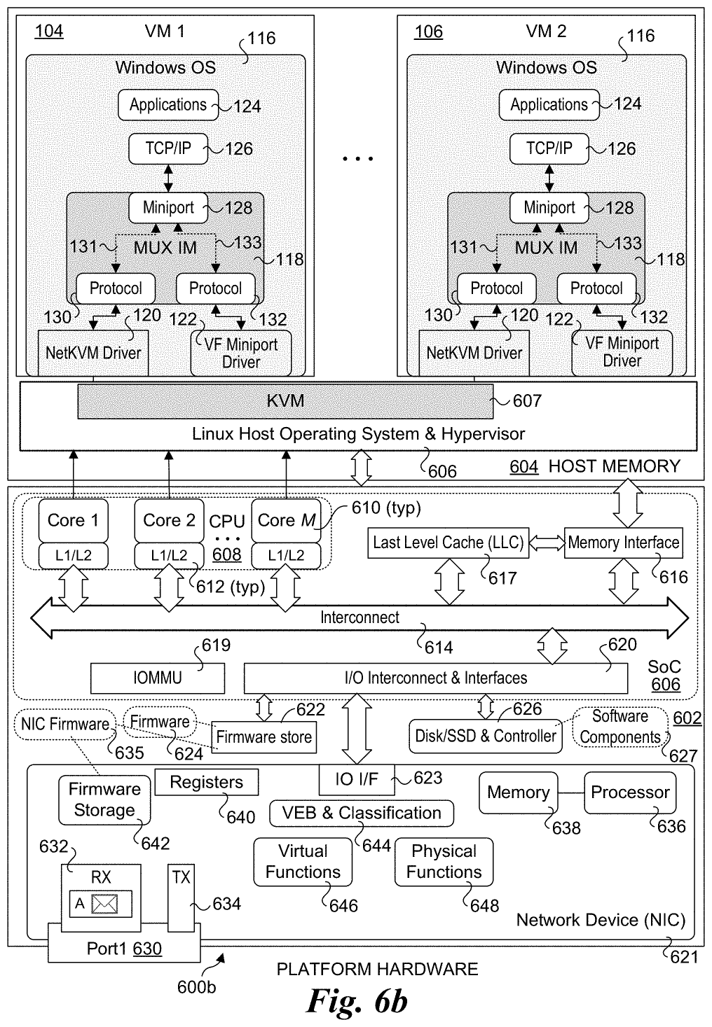

FIG. 6a shows one embodiment of a platform architecture 600a corresponding to a computing or host platform suitable for implementing aspects of the embodiments described herein. Architecture 600a includes a hardware layer in the lower portion of the diagram including platform hardware 602, and a software layer that includes software components running in host memory 604 including a Linux host operating system and Hypervisor 606 with KVM 607.

Platform hardware 602 includes a processor 606 having a System on a Chip (SoC) architecture including a central processing unit (CPU) 608 with M processor cores 610, each coupled to a Level 1 and Level 2 (L1/L2) cache 612. Each of the processor cores and L1/L2 caches are connected to an interconnect 614 to which each of a memory interface 616 and a Last Level Cache (LLC) 618 is coupled, forming a coherent memory domain. Memory interface is used to access host memory 604 in which various software components are loaded and run via execution of associated software instructions on processor cores 610.

Processor 606 further includes an IOMMU (input-output memory management unit) 619 and an IO interconnect hierarchy, which includes one or more levels of interconnect circuitry and interfaces that are collectively depicted as IO interconnect & interfaces 620 for simplicity. In one embodiment, the IO interconnect hierarchy includes a PCIe root controller and one or more PCIe root ports having PCIe interfaces. Various components and peripheral devices are coupled to processor 606 via respective interfaces (not all separately shown), including a network device comprising a NIC 621 via an IO interface 623, a firmware storage device 622 in which firmware 624 is stored, and a disk drive or solid state disk (SSD) with controller 626 in which software components 628 are stored. Optionally, all or a portion of the software components used to implement the software aspects of embodiments herein may be loaded over a network (not shown) accessed, e.g., by NIC 621. In one embodiment, firmware 624 comprises a BIOS (Basic Input Output System) portion and additional firmware components configured in accordance with the Universal Extensible Firmware Interface (UEFI) architecture.

During platform initialization, various portions of firmware 624 (not separately shown) are loaded into host memory 604, along with various software components. In addition to host operating system 606 the software components include software components shown in architecture 200 of FIG. 2 and architecture 300 of FIG. 3. Moreover, other software components may be implemented, such as various components or modules associated with the Hypervisor, VMs, and applications running in the guest OS. Generally, a host platform may host multiple VMs and perform live migration of those multiple VMs in a similar manner described herein for live migration of a VM.

NIC 621 includes one or more network ports 630, with each network port having an associated receive (RX) queue 632 and transmit (TX) queue 634. NIC 621 includes circuitry for implementing various functionality supported by the NIC, including support for operating the NIC as an SR-IOV PCIe endpoint similar to NIC 108 in FIGS. 1 and 3. For example, in some embodiments the circuitry may include various types of embedded logic implemented with fixed or programmed circuitry, such as application specific integrated circuits (ASICs) and Field Programmable Gate Arrays (FPGAs) and cryptographic accelerators (not shown). NIC 621 may implement various functionality via execution of NIC firmware 635 or otherwise embedded instructions on a processor 636 coupled to memory 638. One or more regions of memory 638 may be configured as MMIO memory. NIC further includes registers 640, firmware storage 642, virtual Ethernet bridge (VEB) and classifier 644, one or more virtual functions 646, and one or more physical functions 648. Additional logic (not shown) may be implemented for performing various operations relating to packet processing of packets received for one or more networks, including packet/flow classification and generation of hardware descriptors and the like. Generally, NIC firmware 635 may be stored on-board NIC 621, such as in firmware storage device 642, or loaded from another firmware storage device on the platform external to NIC 621 during pre-boot, such as from firmware store 622.

Generally, CPU 608 in SoC 606 may employ any suitable processor architecture in current use or developed in the future. In one embodiment, the processor architecture is an Intel® architecture (IA), including but not limited to an Intel® x86 architecture, and IA-32 architecture and an IA-64 architecture. In one embodiment, the processor architecture is an ARM®-based architecture.

Software components 627 may further including software components associated with an image of a Microsoft Windows OS, such as Windows 10, a version of Windows Server, etc. Alternatively, the Windows OS image may be stored on a storage device that is accessed over a network and loaded into a portion of host memory 604 allocated to the VM on which the Windows instance will be run. Following boot-up and instantiation of the Linux host OS and Hypervisor and one or more VMs, one or more instances of the Windows OS may be instantiated on a respective VM.

During instantiation of the Windows OS instance, the VF and emulated datapaths will be configured via execution of applicable instructions in the Windows OS and Linux OS. During states related to live migration (e.g., pre-migration, live migration, initial post migration etc.) the Hypervisor will selectively activate the VF or emulated datapath by controlling the state of the SR-IOV VF attached to the VM on which the Windows OS instance is running. It is noted that while migration of a single VM is described and illustrated above, similar operations may be implemented to live migrate multiple VMs.

FIG. 6b shows an embodiment of a platform architecture 600b on which the software components of a host platform architecture 100 of FIG. 1 are implemented. As indicated by like-reference number, the remainder of the software components from Linux host OS and Hypervisor 606 downward are the same in both platform architectures 600a and 600b.

In addition to implementations using SR-IOV, similar approaches to those described and illustrated herein may be applied to Intel® Scalable IO Virtualization (SIOV). SIOV may be implemented on various IO devices such as network controllers, storage controllers, graphics processing units, and other hardware accelerators. As with SR-IOV, SIOV devices and associated software may be configured to support pass-through DMA data transfers both from the SIOV device to the host and from the host to the SIOV device.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” or “coupled in communication” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Italicized letters, such as ‘M’, ‘N’, etc. in the foregoing detailed description and drawings are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for performing live migration of a virtual machine (VM) on which a first instance of a Microsoft Windows operating system (Windows OS) is running, the method implemented on a source host including a Linux operating system with a Hypervisor and a source network device configured to support Single-root Input/Output Virtualization) (SR-IOV) and including a physical function and one or more SR-IOV virtual functions (VFs), the method comprising:
hosting a source VM to be migrated, the source VM attached to an SR-IOV VF via a VF datapath;
employing the VF datapath for communication between the source network device and the source VM;
prior to the live migration, switching communication between the source VM and the source network device from the VF datapath to an emulated datapath from the source VM to the physical function on the source network device; and
during the live migration, employing the emulated datapath for communication between the source VM and the source network device.

2. The method of claim 1, further comprising hot-unplugging the SR-IOV VF and failing over communication between the source VM and the source network device via the emulated datapath to switch from the VF datapath to the emulated datapath.

3. The method of claim 1, wherein the first instance of the Windows OS includes:
an NDIS (Network Driver Interface Specification) MUX IM (intermediate) driver having an NDIS Miniport interface and a first protocol driver; and
a VF Miniport driver, coupled to the first protocol driver,
wherein the VF datapath is coupled between the VF Miniport driver and the SR-IOV VF on the source network device.

4. The method of claim 3, wherein the NDIS MUX IM driver further includes a second protocol driver, wherein the Hypervisor includes a Kernel-based Virtual Machine (KVM) and the first instance of the Windows OS includes a NetKVM driver coupled to the second protocol driver, and wherein the emulated datapath path employs the NetKVM driver.

5. The method of claim 4, wherein the Hypervisor includes a VirtIO-NET backend, a software (SW) switch, and a Physical Function (PF) driver, wherein the emulated path is from the NetKVM driver to the VirtIO-NET backend to the SW Switch to the PF driver to the physical function on the network device, and
wherein the MUX IM driver is configured to selectively activate a communication path between the NDIS Miniport interface and the first protocol driver to make the VF datapath an active datapath, and to selectively activate a communication path between the NDIS Miniport interface and the second protocol driver to make the emulated datapath the active datapath.

6. The method of claim 1, wherein the Hypervisor includes a Kernel-based Virtual Machine (KVM) and the first instance of the Windows OS includes a VF Miniport driver and a NetKVM driver with an integrated an NDIS (Network Driver Interface Specification) MUX IM (intermediate) driver having an NDIS Miniport interface and a protocol driver coupled to the VF Miniport driver, and wherein the VF datapath is coupled between the VF Miniport driver and the SR-IOV VF on the source network device

7. The method of claim 6, wherein the Hypervisor includes a VirtIO-NET backend, a software (SW) switch, and a Physical Function (PF) driver, wherein the emulated path is from the NetKVM driver to the VirtIO-NET backend to the SW Switch to the PF driver to the physical function on the network device,
wherein the MUX IM driver is configured to selectively activate a communication path between the NDIS Miniport interface and the protocol driver to make the VF datapath an active datapath, and to selectively activate a communication path between the NDIS Miniport interface and the VirtIO-NET backend to make the emulated datapath the active datapath.

8. The method of claim 1, wherein the method is further implemented on a destination host including a second Linux operating system with a Hypervisor and a destination network device configured to support SR-IOV and including a physical function and one or more SR-IOV virtual functions (VFs), further comprising:
at the destination host,
hosting a destination VM running a second instance of the Windows OS to which the source VM is to be migrated, the destination host employing an emulated datapath between the destination VM and the physical function on the source network device; and
migrating the source VM to the destination VM during the live migration, the migration resulting in the destination VM being implemented as a migrated VM.

9. The method of claim 8, further comprising:
following migration of the source VM to the destination VM;
attaching an SR-IOV VF on the destination network device to the migrated VM via a VF datapath; and
switching from the emulated datapath to the VF datapath to facilitate communication between the migrated VM and the destination network device.

10. The method of claim 8, wherein the SR-IOV VF on the destination network device is hot-added while the emulated datapath is being employed, wherein hot-adding the SR-IOV VF automatically switches the datapath between the migrated VM and the destination network device from the emulated datapath to the VF datapath.

11. A non-transitory machine-readable medium having instructions stored thereon configured to be executed on a processor of a host platform to enable support for live migration of a first virtual machine (VM) on which a Microsoft Windows operating system (Windows OS) is running, the host platform including a Linux operating system with a Hypervisor hosting the first VM and a network device configured to support Single-root Input/Output Virtualization (SR-IOV) and including a physical function and one or more SR-IOV virtual functions (VFs), wherein execution of the instruction enables the host platform to:
attach the first VM to an SR-IOV VF on the network device via a VF datapath;
employ the VF datapath for communication between the network device and the first VM;
prior to the live migration of the first VM, switching communication between the first VM and the network device from the VF datapath to an emulated datapath from the first VM to the physical function on the network device; and
during the live migration of the first VM, employ the emulated datapath for communication between the first VM and the network device.

12. The non-transitory machine-readable medium of claim 11, wherein a portion of the instructions, upon execution, fails over communication between the VM and the network device via the emulated datapath to switch from the VF datapath to the emulated datapath in response to the SR-IOV VF being hot-unplugged.

13. The non-transitory machine-readable medium of claim 11, wherein the instructions comprise a plurality of Windows OS software components including:
an NDIS (Network Driver Interface Specification) MUX IM (intermediate) driver having an NDIS Miniport interface and a first protocol driver; and
a VF Miniport driver, coupled to the first protocol driver,
wherein the VF datapath is coupled between the VF Miniport driver and the SR-IOV VF on the network device and wherein execution of the instructions enables the first protocol driver to be selectively coupled in communication with the NDIS Miniport interface to make the VF datapath an active datapath.

14. The non-transitory machine-readable medium of claim 11, wherein the Hypervisor includes a Kernel-based Virtual Machine (KVM) and the Windows OS software components include a NetKVM MUX IM (intermediate) driver, and wherein the emulated datapath path employs the NetKVM MUX IM driver.

15. The non-transitory machine-readable medium of claim 14, wherein the Hypervisor includes a VirtIO-NET backend, a software (SW) switch, and a Physical Function (PF) driver, wherein the emulated path is from the NetKVM driver to the VirtIO-NET backend to the SW Switch to the PF driver to the physical function on the network device, and
wherein the MUX IM driver is configured, upon execution of a portion of the instructions, to selectively activate a communication path between the NDIS Miniport interface and the first protocol driver to make the VF datapath an active datapath, and to selectively activate a communication path between the NDIS Miniport interface and the second protocol driver to make the emulated datapath the active datapath.

16. The non-transitory machine-readable medium of claim 11, wherein the Hypervisor includes a Kernel-based Virtual Machine (KVM) and wherein the instructions comprise a plurality of Windows OS software components including a VF Miniport driver and a NetKVM driver with an integrated an NDIS (Network Driver Interface Specification) MUX IM (intermediate) driver having an NDIS Miniport interface and a protocol driver, wherein the VF Miniport driver is coupled in communication with the protocol driver upon execution of a first portion of the instructions, and wherein the VF Miniport driver is attached to the SR-IOV VF on the network device upon execution of a second portion of the instructions to implement the VF datapath.

17. The non-transitory machine-readable medium of claim 16, wherein the Hypervisor includes a VirtIO-NET backend, a software (SW) switch, and a Physical Function (PF) driver, wherein the emulated path is from the NetKVM driver to the VirtIO-NET backend to the SW Switch to the PF driver to the physical function on the network device, and
wherein the MUX IM driver is configured, upon execution of respective portions of the instructions, to selectively activate a communication path between the NDIS Miniport interface and the protocol driver to make the VF datapath an active datapath, and to selectively activate a communication path between the NDIS Miniport interface and the VirtIO-NET backend to make the emulated datapath the active datapath.

18. The non-transitory machine-readable medium of claim 11, wherein the host platform is configured to operate as a destination host in connection with live migration of a source VM on a source host to the destination host, the source VM running a first instance of a Windows OS and hosted by a Linux operating system and a Hypervisor running on the source host, wherein execution of the instructions facilitates operations relating to the live migration of the source VM to the destination host that are implemented on the destination host, including configuring a destination VM on the destination host running a second instance of the Windows OS to which the source VM is to be migrated to employ a second emulated datapath between the destination VM and the physical function on the network device.

19. The non-transitory machine-readable medium of claim 18, wherein following migration of the source VM to the destination VM the destination VM becomes a migrated VM, and wherein execution of the instructions further enables the host platform to:
attach an SR-IOV VF on the network device to the migrated VM via a second VF datapath; and
switch from the second emulated datapath to the second VF datapath to facilitate communication between the migrated VM and the network device.

20. The non-transitory machine-readable medium of claim 19, wherein execution of the instructions causes the SR-IOV VF to be hot-added while the second emulated datapath is being employed, wherein hot-adding the SR-IOV VF automatically switches the datapath between the migrated VM and the network device from the second emulated datapath to the second VF datapath.

21. A compute platform, comprising:
a processor, having a plurality of cores and a Peripheral Component Interconnect Express (PCIe) interface;
memory, communicatively coupled to the processor;
a network device, communicatively coupled to the PCIe interface, configured to support Single-root Input/Output Virtualization) (SR-IOV) and including a physical function and one or more SR-IOV virtual functions (VFs);
a storage device, communicatively coupled to the processor; and
a plurality of instructions stored in at least one of the storage device and memory and configured to be executed on at least a portion of the plurality of cores, the plurality of instructions comprising a first plurality of software components associated with a Microsoft Windows operating system (Windows OS) and a second plurality of software components associated with a Linux operating system (OS) including a Hypervisor, wherein execution of the instruction enables the host platform to,
host, via the Linux OS, a virtual machine (VM);
instantiate a first instance of the Windows OS on the first VF;
attach the VM to an SR-IOV VF on the network device via a VF datapath;
employ the VF datapath for communication between the network device and the VM;
prior to a live migration of the VM to a second compute platform, switch communication between the VM and the network device from the VF datapath to an emulated datapath from the VM to the physical function on the network device; and
during the live migration of the VM, employ the emulated datapath for communication between the VM and the network device.

22. The compute platform of claim 21, wherein the Hypervisor includes a Kernel-based Virtual Machine (KVM) and wherein the plurality of Windows OS software components includes a VF Miniport driver and a NetKVM driver, wherein the Hypervisor includes a VirtIO-NET backend, a software (SW) switch, and a Physical Function (PF) driver, and wherein the emulated path is from the NetKVM driver to the VirtIO-NET backend to the SW Switch to the PF driver to the physical function on the network device, and wherein the VF datapath is coupled between the VF Miniport driver and the SR-IOV VF on the network device upon execution of a portion of the instructions.

23. The compute platform of claim 22, wherein the compute platform is configured to use the VF datapath when the SR-IOV VF is attached and fail over to the emulated datapath when the SR-IOV VF is not attached, and wherein execution of a second portion of the instructions switches the datapath to the emulated datapath by hot-unplugging the SR-IOV VF.

24. The compute platform of claim 22, the NetKVM driver has an integrated NDIS (Network Driver Interface Specification) MUX IM (intermediate) driver with an NDIS Miniport interface and a protocol driver coupled to the VF Miniport driver, and wherein the NetKVM driver is configured, upon execution of respective portions of the instructions, to selectively couple the NDIS Miniport interface to the protocol driver to make the VF datapath an active datapath, and to selectively couple the NDIS Miniport interface to the VirtIO-NET backend to make the emulated datapath the active datapath.

25. The compute platform of claim 22, wherein the plurality of Windows OS software components include an NDIS (Network Driver Interface Specification) MUX IM (intermediate) driver comprising an NDIS Miniport Interface, a first protocol driver to which the VF Miniport driver is coupled and a second protocol driver to which the NetKVM driver is coupled, wherein, via execution of a portion of the instructions, the NDIS MUX IM driver is configured to selectively couple the first protocol driver in communication with NDIS Miniport interface to use the VF datapath when the SR-IOV VF is attached and fail over to the emulated datapath when the SR-IOV VF is not attached by selectively coupling the second protocol driver in communication with the NDIS Miniport interface.
